(19) United States
(12) Patent Application Publication
(10) Pub. No.: US 2026/0054615 A1
(43) Pub. Date: Feb. 26, 2026

(54) Car Seat Occupancy Mat Device

(71) Applicant: Jose Robelo, Homestead, FL (US)

(72) Inventor: Jose Robelo, Homestead, FL (US)

(21) Appl. No.: 18/810,027

(22) Filed: Aug. 20, 2024

(51) Int. Cl. B60N 2/26

(52) U.S. Cl. CPC B60N 2/267; B60N 2210/30; B60N 2210/40; B60N 2230/20

(57) ABSTRACT

A system for preventing a child from being inadvertently left behind in a child car seat. A mat is configured to be positioned under a bottom pad and rest on a seat bottom of the child car seat. The mat is generally U-shaped to fit around the harness system of the child car seat. A pressure sensing component is integrated or attached to the mat to indicate the presence of a child in the child car seat. A controller in electrical communication with the pressure sensor is configured to receive the pressure sensor data and notify the user if the child is still in the child car seat. A temperature sensor is used to warn the user if a temperature reaches a dangerous level. The controller may notify the user via a mobile application accessible via a mobile electronic device.

### FIELD OF THE INVENTION

The present invention relates generally to the field of car seat occupancy alerting devices. More specifically, the present invention relates to a car seat occupancy mat device with a body housing a pressure sensor that can be placed underneath the cushion of a car seat. Once the sensor detects the presence of a child in the seat, the device alerts a user via a mobile application if the child is still present in the seat once a user travels a specific distance away from the seat. Accordingly, the present disclosure makes specific reference thereto. Nonetheless, it is to be appreciated that aspects of the present invention are also equally applicable to other like applications, devices, and methods of manufacture.

### BACKGROUND

Individuals may experience minor lapses in attention, often due to distractions or sudden changes in routines. Such unintentional oversights, like forgetting a child strapped into a car seat inside a vehicle, can have lethal consequences as the interior temperature of a vehicle can escalate rapidly, thus trapping the child in a life-threatening situation. A child body can heat up almost five times faster than an adult body making children especially vulnerable to heat exhaustion or heat stroke. These conditions can damage a child's brain and other organs, and in severe cases, can lead to death.

Existing child safety seats are designed to keep children and infants safe in the event of an automobile accident. They are designed for use in the back seat of the vehicle, so they are not readily visible to a front seat passenger or driver. They come is a variety of configurations based on the child's age and weight. There are infant only car seats, integrated or detachable seat and base combinations, rear and forward facing car seats, and booster seats. The car seats generally have a back rest, a seat portion with a pad, and a harness system that secures the arms, torso, and legs of the child. There is also a cutout in the seat pad and seat bottom where the leg straps penetrate the seat bottom and connect to a buckle. However, while these devices are designed to help a child survive a crash, they secure the child and prevent self-extrication in the event the child is inadvertently left behind or when another dangerous condition occurs.

Therefore, there exists a long-felt need in the art for a device that notifies a user if a child is forgotten in the back seat of a vehicle. There also exists a long-felt need in the art for a car seat occupancy mat system that notifies a user and emergency services if a child is forgotten in a back seat of a vehicle. Further, there exists a long-felt need in the art for a car seat occupancy mat system that notifies a user and emergency services if a child is forgotten in the back seat of a vehicle if the temperature within the vehicle reaches a specific temperature.

In this manner, the car seat occupancy mat system of the present invention accomplishes all the forgoing objectives and provides a device and system that notifies a user if a child is left behind in the back seat of a vehicle. If a child is indeed forgotten in the back seat of a vehicle, the system may be configured to automatically notify a user or emergency services. Further, the system may also notifies a user and emergency services if a child is in the back seat of a vehicle if the temperature within the vehicle reaches a specific temperature.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a car seat occupancy detection system. The car seat occupancy detection system comprises a mat, a pressure sensor, and a controller. The mat is positional on a seat bottom of a child car seat. The mat comprises a top and a bottom. The mat further comprises a front portion, a pair of legs extending out of the front portion, and a cut-out positioned between the pair of legs. The cut-out is configured to fit around a harness system extending out of the seat bottom of the child car seat. The bottom of the mat frictionally engages the seat bottom of the child car seat.

The pressure sensor is attached to or integrated into the mat. The pressure sensor may be sandwiched between the top and bottom of the mat, or may be externally attached to the top or the bottom of the mat. The pressure sensor may be a force or pressure sensor and may be adjustable in sensitivity.

The controller is in electrical communication with the pressure sensor. The controller is configured to notify a user when the pressure sensor detects pressure on the mat. The controller may be connected to the pressure sensor via a wired connection or wirelessly. The controller comprises a transmitter, a battery, and a charging port. The controller may further comprise a speaker and a visual indicating element.

The car seat occupancy detection system may further comprise a temperature sensor. The temperature sensor may be adjustable in sensitivity. The temperature sensor may be housed within the controller or may be attached to the mat. The controller is in electrical communication with the temperature sensor. The controller is configured to notify a user when the temperature sensor detects a temperature above a predetermined threshold.

The car seat occupancy detection system may further comprise a mobile application. The mobile application is configured to be in communication with the controller via the transmitter. The mobile application is generally accessible via a mobile electronic device. The mobile application is further configured to notify the user when the mobile application receives information from the controller related to the detected pressure or a temperature detected above the threshold.

Accordingly, the car seat occupancy detection system of the present invention is particularly advantageous as it provides a system that notifies a user if a child is forgotten in the back seat of a vehicle. If a child is indeed forgotten in the back seat of a vehicle, the system may automatically notifies a user and emergency services. Further, the car seat occupancy detection system also notifies a user or emergency services if a child is forgotten in the back seat of a vehicle if the temperature within the vehicle reaches a specific temperature. In this manner, the car seat occupancy mat system provides a solution to ensuring children are not inadvertently left behind in car seats.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a car seat occupancy detection system of the present invention for use with a child car seat in accordance with the disclosed architecture;

FIG. 2 illustrates a perspective view of the car seat occupancy detection system of the present invention in place under a bottom pad of the child car seat in accordance with the disclosed architecture;

FIG. 3 illustrates a perspective view of the car seat occupancy detection system of the present invention in place under a bottom pad of the child car seat in accordance with the disclosed architecture;

FIG. 4 illustrates a top view of a mat of the car seat occupancy detection system of the present invention for use with the child car seat in accordance with the disclosed architecture;

FIG. 5 illustrates a bottom view of the mat of the car seat occupancy detection system of the present invention for use with the child car seat in accordance with the disclosed architecture;

FIG. 6 illustrates a perspective view of a controller of the car seat occupancy detection system of the present invention for use with the child car seat in accordance with the disclosed architecture; and

FIG. 7 illustrates a perspective view of a mobile application of the car seat occupancy detection system of the present invention for use with the child car seat in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that notifies a user if a child is forgotten in the back seat of a vehicle. There also exists a long-felt need in the art for a car seat occupancy detection system that notifies a user and emergency services if a child is forgotten in a back seat of a vehicle. Further, there exists a long-felt need in the art for a car seat occupancy detection system that notifies a user and emergency services if a child is forgotten in the back seat of a vehicle if the temperature within the vehicle reaches a specific temperature.

The present invention, in one exemplary embodiment, is a system for preventing a child from being inadvertently left behind in a child car seat. A mat is configured to be positioned under a bottom pad and rest on a seat bottom of the child car seat. The mat is generally U-shaped to fit around the harness system of the child car seat. A pressure sensing component is integrated or attached to the mat to indicate the presence of a child in the child car seat. A controller in electrical communication with the pressure sensor is configured to receive the pressure sensor data and notify the user if the child is still in the child car seat. A temperature sensor is used to warn the user if a temperature reaches a dangerous level. The controller may notify the user via a mobile application accessible via a mobile electronic device.

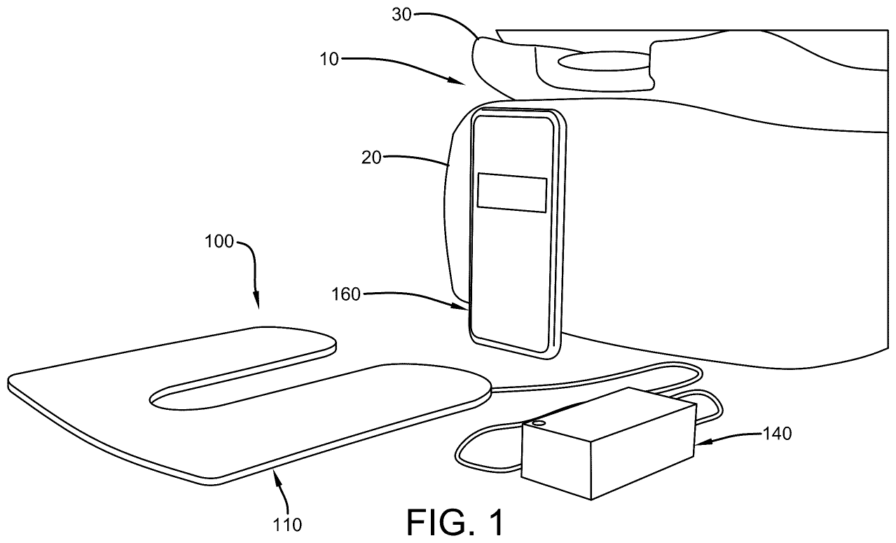

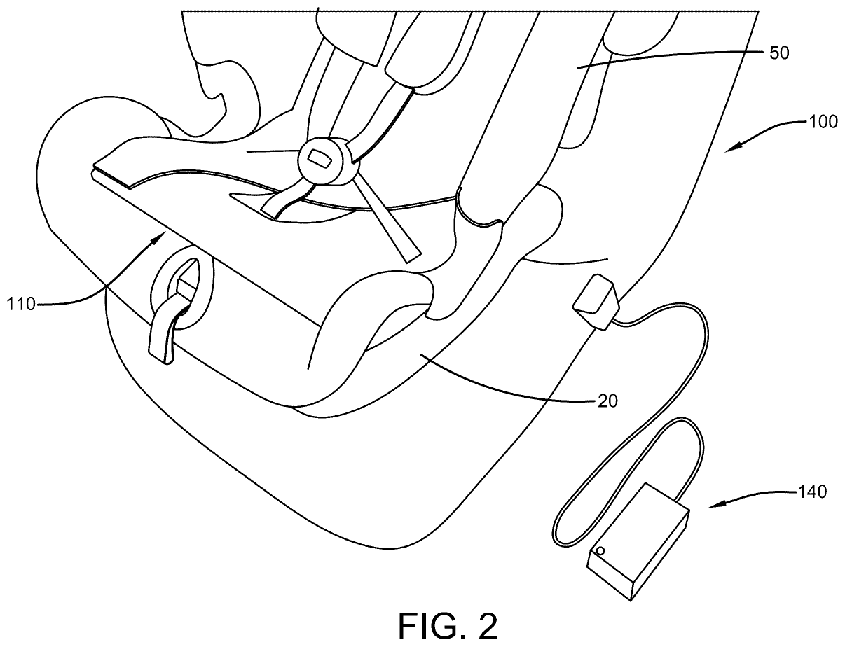

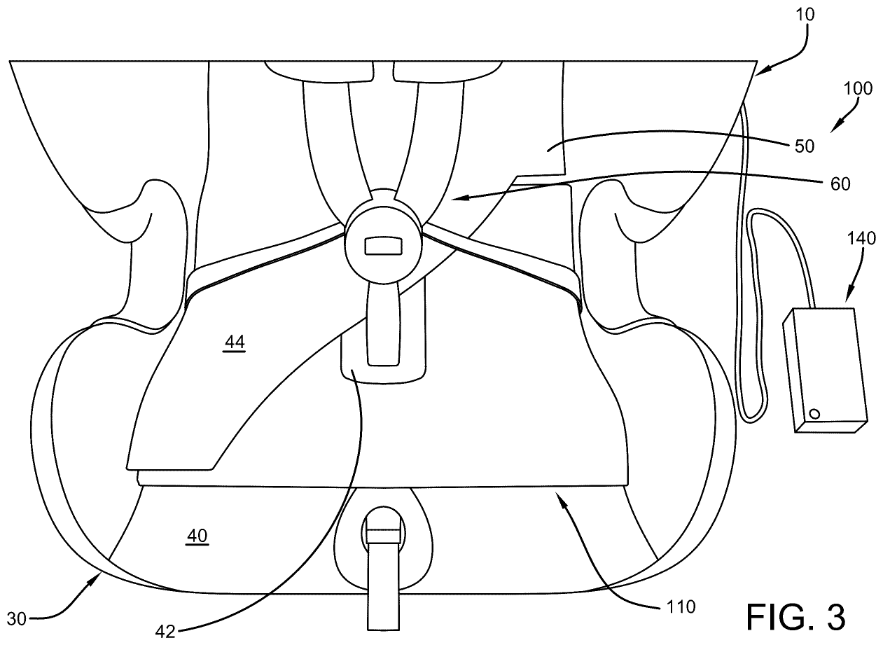

Referring initially to the drawings, FIGS. 1-7 illustrate a car seat occupancy detection system 100. As illustrated in FIGS. 1-3, the car seat occupancy detection system 100 is for use with a child car seat 10. The child car seat 10 may be an infant car seat, a rear facing child car seat, a front facing child car seat, a child car seat and base combination, a booster seat, and the like. The child car seat 10 may have a base 20 and a seat 30. The seat 30 typically has a seat bottom 40, a back rest 50, and a harness system 60. The seat bottom 30 has a strap cut out 42 and a bottom pad 44 that has a cut out.

The car seat occupancy detection system 100 comprises a mat 110, a pressure sensor 130, and a controller 140. The mat 110 is typically positioned between the bottom pad 44 and on the seat bottom 30 of the child car seat 10, but may be alternatively positioned under the seat 30 or the base 20 as desired. The mat 110 is configured to fit around the strap cut out 42 for the harness system 60 of the child car seat 10.

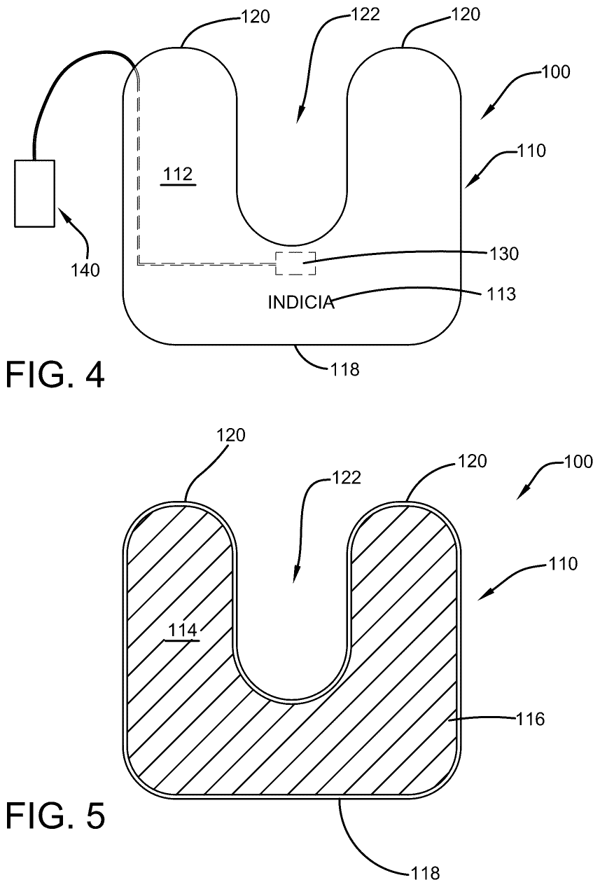

As illustrated in FIGS. 4 and 5, the mat 110 comprises a top 112 and a bottom 114. The mat 110 further comprises a front portion 118, a pair of legs 120, and a cut out 122. The pair of legs 118 extend out of the front portion 118, and the cut-out 122 is positioned between the pair of legs 120 creating a generally U-shaped mat. The cut-out 122 is configured to fit around the strap cut out 42 for the harness system 60 of the child car seat 10.

The mat 110 may be comprised of any material, such as, but not limited to, silicon, plastic, canvas, polymer materials, natural fabric materials, and the like. The mat 110 may further have a waterproof coating or layer, or an antimicrobial coating or layer. The top 112 of the mat 110 may comprise an indicia 113, such as words, symbols, logos, patterns, characters, a warning label, instructions, and the like. The bottom 114 is configured to frictionally engage the seat bottom 40 of the child car seat 10. The bottom 114 may comprise a non-slip element 116. The non-sip element 116 may be a texture, knurling, a friction layer, raised elements, and the like. The non-slip element 116 may be a raised or recessed texture to prevent sliding/movement when placed in a child car seat 10.

The pressure sensor 130 is attached to or integrated into the mat 110. The pressure sensor 130 may be sandwiched between the top 112 and the bottom 114 of the mat 110. Alternatively, the pressure sensor 130 may be externally attached to the top 112 and the bottom 114 of the mat 110. The pressure sensor 130 may be a force or pressure sensor of any type, such as, but not limited to load cells, strain gauges, microelectromechanical systems, force sensitive resistors, and the like. The pressure sensor 130 may also be a pressure pad or a thin film pressure sensor. The pressure sensor 130 may be adjustable in sensitivity to accommodate children of different weights.

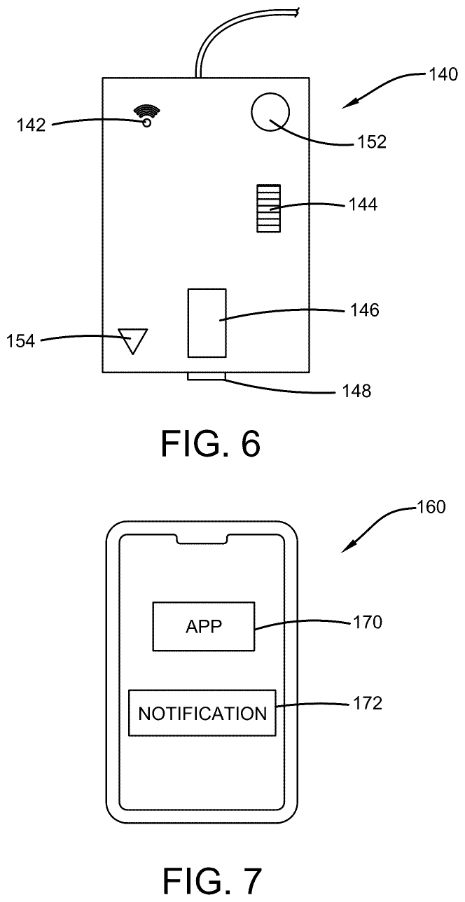

As further illustrated in FIG. 6, the controller 140 is in electrical communication with the pressure sensor 130. The controller 140 is configured to notify a user when the pressure sensor 130 detects pressure. The controller 130 may comprise a wired connector 150 for connecting the controller 140 to the pressure sensor 130. Alternatively, the controller may be connected to the pressure sensor 130 wirelessly. The controller 140 further comprises a transmitter 142, a battery 146, and a charging port 148. The transmitter 142 may be an RFID antenna, a Bluetooth® antenna, or any similar antenna. The battery 146 may be a disposable or rechargeable battery. The charging port 148 may be a USB port, fire wire port, a micro-USB, a USB-C, and the like.

The car seat occupancy detection system 100 may further comprise a temperature sensor 144. The temperature sensor 144 may be adjustable in sensitivity so that the user can determine a dangerous temperature threshold. The temperature sensor 144 may be housed within the controller 140 or may be attached to or otherwise integrated within the mat 110. The controller 140 is in electrical communication with the temperature sensor 144. The controller 140 is configured to notify a user when the temperature sensor 144 detects a temperature above a predetermined threshold.

The controller 140 may further comprise a speaker 152 and a visual indicating element 154. The speaker 152 may be configured to provide an audible alert in the event that the pressure sensor 130 detects pressure or when the temperature sensor 144 detects a temperature above a predetermined threshold. The visual indicating element 154 may be light emitting diode lamp or strip. The visual indicating element 154 is configured to provide a visual alert in the event that the pressure sensor 130 detects pressure or when the temperature sensor 144 detects a temperature above a predetermined threshold. The visual alert may be in the form of a specific color, or a pattern of flashes, or a combination thereof.

As illustrated in FIG. 7, the car seat occupancy detection system 100 may further comprise a mobile application 170. The mobile application 170 is configured to be in communication with the controller 140 via the transmitter 142. The mobile application 170 is generally accessible via a mobile electronic device 160, such as a smart phone.

The mobile application 170 is further configured provide a notification 172 the user when the mobile application 170 receives information from the controller in the event that the pressure sensor 130 detects pressure or when the temperature sensor 144 detects a temperature above a predetermined threshold. The notification 172 may also be triggered when the mobile application 170 detects pressure when the user travels a distance away from the child car seat 10 with the child still in the seat as detected by the pressure sensor 130. The notification 172 may be in the form of a call, a text, an email, a push notification, or an audible alert.

The notification 172 can be configured to notify a user only if the smart device 160 that the mobile application 170 is installed upon travels a specific distance from the controller 140. That specific distance can be set by the user. Once a user is notified, the user can disable the notification 172 via the mobile application 170. If the user does not disable the notification 172 in a specific amount of time that can be chosen by the user, the mobile application 170 may be configured to automatically notify a second user. The second user may be in the form of a first responder agency or a secondary user chosen by the first user, wherein the contact details of the secondary user are stored in the mobile application 170.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “car seat occupancy detection system” and “system” are interchangeable and refer to the car seat occupancy detection system 100 of the present invention.

Notwithstanding the forgoing, the car seat occupancy detection system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the car seat occupancy detection system 100 as shown in the FIGS. are for illustrative purposes only, and that many other sizes and shapes of the car seat occupancy detection system 100 are well within the scope of the present disclosure. Although the dimensions of the car seat occupancy detection system 100 are important design parameters for user convenience, the car seat occupancy detection system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A car seat occupancy detection system comprising:
a mat comprising a top, a bottom, a front portion, a pair of legs extending out of the front portion, and a cut-out positioned between the pair of legs;
a pressure sensor attached to the mat; and
a controller in electrical communication with the pressure sensor, wherein the controller is configured to provide a notification if the pressure sensor detects pressure.

2. The car seat occupancy detection system of claim 1, wherein the pressure sensor is integrated into the mat between the top and the bottom.

3. The car seat occupancy detection system of claim 1, wherein the pressure sensor is a pressure pad.

4. The car seat occupancy detection system of claim 1, wherein the pressure sensor is a thin film pressure sensor.

5. The car seat occupancy detection system of claim 1, wherein the top of the mat comprises an indicia.

6. The car seat occupancy detection system of claim 1, wherein the bottom of the mat comprises a non-slip element.

7. The car seat occupancy detection system of claim 6, wherein the non-slip element is a textured surface.

8. The car seat occupancy detection system of claim 1, wherein the controller is connected to the pressure sensor via a wired connection.

9. The car seat occupancy detection system of claim 1, wherein the controller is connected to the pressure sensor wirelessly.

10. A car seat occupancy detection system for use with a child safety seat, the car seat occupancy detection system comprising:
a mat comprising a top, a bottom, a front portion, a pair of legs extending out of the front portion, and a cut-out positioned between the pair of legs;
a pressure sensor attached to the mat;
a temperature sensor; and
a controller in electrical communication with the pressure sensor and the temperature sensor, wherein the controller is configured to provide a notification if the pressure sensor detects pressure or if the temperature sensor detects a temperature above a predetermined threshold.

11. The car seat occupancy detection system of claim 10, wherein the controller comprises a transmitter.

12. The car seat occupancy detection system of claim 10, wherein the controller comprises a USB charging port.

13. The car seat occupancy detection system of claim 10, wherein the controller comprises a speaker.

14. The car seat occupancy detection system of claim 10, wherein the controller comprises a visual indicating element.

15. The car seat occupancy detection system of claim 14, wherein the visual indication element is a light emitting diode lamp.

16. The car seat occupancy detection system of claim 10, wherein the bottom of the mat comprises a non-slip textured surface.

17. The car seat occupancy detection system of claim 10, wherein the pressure sensor is a pressure pad or a thin film pressure sensor attached to the top of the mat.

18. The car seat occupancy detection system of claim 10, wherein the pressure sensor is adjustable.

19. The car seat occupancy detection system of claim 10, wherein the temperature sensor is adjustable.

20. A car seat occupancy detection system for use with a child safety seat, the car seat occupancy detection system comprising:
a mat comprising a top, a bottom, a front portion, a pair of legs extending out of the front portion, and a cut-out positioned between the pair of legs;
a pressure sensor integrated into the mat between the top and the bottom;
a temperature sensor;
a controller in electrical communication with the pressure sensor and the temperature sensor; and
a mobile application in communication with the controller, wherein the mobile application is configured to provide a notification if the pressure sensor detects pressure or if the temperature sensor detects a temperature above a predetermined threshold.
